(19) United States
(12) Patent Application Publication
(10) Pub. No.: US 2021/0265895 A1
(43) Pub. Date: Aug. 26, 2021

(54) GRAYSON RANGE EXTENDER (GRE): Wheel-based frictionless generator type range extender and recharger for electric vehicles

(71) Applicant: Michael Grayson, Hollis, NY (US)

(72) Inventor: Michael Grayson, Hollis, NY (US)

(21) Appl. No.: 16/801,505

(22) Filed: Feb. 26, 2020

(51) Int. Cl. H02K 7/18; B60L 53/50; B60L 50/90; B60L 53/60; H02K 11/00; H02J 7/00

(52) U.S. Cl. CPC H02K 7/1846; B60L 53/50; H02J 7/007; B60L 53/60; H02K 11/0094; B60L 50/90

(57) ABSTRACT

A wheel-based generator of a range extender and recharger for an electric vehicle is characterized by comprising an armature winding, wheel cover, wheel well, tire, permanent magnets, spokes, charge controller and battery bank. This is a frictionless, high efficiency, brushless generator design that utilizes the wheel well and or wheel cover, together with the mechanical energy of the tire itself to create a frictionless brushless generator that will deliver power to the engine directly or can be diverted to the battery bank for recharging.

### TECHNICAL FIELD

The present invention relates to a kind of wheel-based range extender and recharger for electric vehicles dramatically increasing the vehicles driving range and greatly reducing or eliminating the need for recharging, this device is called the Grayson Range Extender (GRE), belong to car electrics technical field.

### BACKGROUND TECHNOLOGY

Although pure electric automobiles have the advantage of energy-savings, environmental protection, and zero discharge, the continual mileage range is currently very limited. In order to achieve mass application and acceptance the electric vehicle range must meet or exceed that of conventional fossil fuel powered vehicles. Currently 400 miles is the average range for a fossil fuel vehicle. This range has become standard and is very consumer friendly because of the fact that there is a wide choice of gas stations available and refueling takes only five minutes. It would be very easy to give gas cars a higher range, just put in a bigger tank. For electric vehicles the solution is not as simple. The average range of an electric vehicle is currently 150 miles. Adding more battery as the solution for perceived range needs only adds more cost to the profitability-challenged electrified vehicle. Vehicle Costs Already Too High for Mainstream Customers and given the inherent cost disadvantages faced by EV's vs. conventional vehicles and less financial policy support in the future, even the current $50 per additional mile of cost to the vehicle is quite impractical, given the number/frequency of trips that truly require most of the battery range.

Larger batteries will also incur larger warranty expenses for the OEM as well as greater freight & recycling costs.

More Mass on the Vehicle. Batteries are very heavy. Compensating with Lightweight Materials is Expensive. In order to meet very stringent fuel economy & CO2 targets globally (primarily China, Europe, US & CA), all vehicles will have to be lighter and more mass efficient. Automotive OEM's will pay more in premium materials for weight savings. Adding 4 lbs. of battery mass is roughly equal to 1 mile of EV range.

Longer Charging Times to Top-off. Charging Infrastructure for Long Distance Trips under currently under Development however no solution is close at hand.

Key Customers today are very accustomed to short re-fueling times at gas stations. Charging an EV is a much different experience and has been a challenge since the days of Edison's efforts to supply the first batteries for electric cars. The larger the batteries become, the more and faster charging solutions that are required and continuous high-power charging can increase battery degradation.

Less Packaging Space for other Components. More Stuff on Vehicles Expected with High Tech Features and Autonomous driving leaves less room for batteries and not more. As batteries become larger to provide more range, given a fixed vehicle size, packaging of components and new features become an acute challenge for all of the elements requiring space within the vehicle architecture including passenger and cargo carrying expectations. Future self-driving systems will further accentuate this issue as well as require more energy consumption.

More Structural Requirements for Crashworthiness. Must Protect the Bigger Batteries. We are often reminded that both gas tanks and batteries contain so much energy and they need to be carefully protected from thermal events that can occur during crashes. Larger batteries are greater engineering challenges requiring more substantive structures/systems.

More Robust Support Systems Required Mass Begets Mass As the battery grows and the mass of the vehicle increases, other components from brakes, suspension, thermal management, etc. must be designed and reinforced to handle these challenges; the result is even more mass and cost added to the vehicle.

Without solutions to all these problems the electric vehicle just cannot advance. The GRE addresses each of these problems in a practical, reliable and cost-effective way. My wheel based permanent magnet generator has the advantage of high efficiency, high power density, and has more wide application prospect.

In existing technology, the GRE will prove to be a compatible device that can quickly integrate with all current electrical vehicle platforms. The present invention proposes the conversion of the wheel assembly into a permanent magnet generator.

### BRIEF DESCRIPTION OF THE DRAWINGS

FIG. 1 (1A-1C) is the sectional view of a kind of wheel-type electric vehicle generator range extender and recharger of the present invention, the Grayson Range Extender (GRE).

FIG. 2 (2A-2D) is the sectional view of a kind of wheel-type electric vehicle generator range extender and recharger of the present invention, the Grayson Range Extender (GRE).

FIG. 3 is the sectional view of a kind of wheel-type electric vehicle generator range extender and recharger of the present invention, the Grayson Range Extender (GRE).

FIG. 4 (4A-4C) is the sectional view of a kind of wheel-type electric vehicle generator range extender and recharger of the present invention, the Grayson Range Extender (GRE).

FIG. 5 (5A-5E) is the sectional view of a kind of wheel-type electric vehicle generator range extender and recharger of the present invention, the Grayson Range Extender (GRE).

### SUMMARY OF THE INVENTION

A kind of frictionless wheel-based range extender and recharger for electric vehicles, dramatically increasing the electric vehicle driving range and greatly reducing or eliminating the need for recharging, effectively lowering the sprung weight of the vehicle and speeding recharge times.

A wheel-based generator of a range extender and recharger for an electric vehicle is characterized by comprising an armature winding, wheel cover, wheel well, tire, permanent magnets, spokes, charge controller and battery bank. This is a frictionless, high efficiency, brushless generator design that utilizes the wheel well and or wheel cover, together with the mechanical energy of the tire itself to create a frictionless brushless generator that will deliver power to the engine directly or can be diverted to the battery bank for recharging. This device can be configured several ways. The two primary ways to configure this device are denoted in this application as Device 1 and Device 2. In the case of Device 1 the magnet, copper or enameled wire is wound tightly around an iron core and fashioned such that it is encompassed by the wheel cover/wheel well. The wheel cover is fixed for the rear tires and is movable for the front tires. This armature takes up a large percentage of the wheel well or cover. This assembly constitutes the stator body housing and has Electrodes made of soft iron. This armature winding is completely concealed by the wheel cover/well and is in the shape of the wheel cover. This dense magnet wiring cluster forms the first major segment of the Device 1 generator. There are several layers of wire in this cluster. The armature coil is stationary. The magnetic field is created through electric current in the wire-wound coil and strengthened by a soft-iron core. The armature coil assembly converts the mechanical energy of the rotating tire into electrical energy by passing the permanent magnet wheel spokes through this armature winding. The wheel, which houses the permanent magnets on the wheel spokes. The wheel thus becomes the rotor. The Rotor produces rotating magnetic flux or rotating magnetic field associated with the rotor inducing electricity in the armature coil attached to the wheel well or wheel cover. The electricity produced is then diverted to the charge controller. The charge controller now powers the engine directly or recharges the battery based on the current needs of the vehicle. Permanent steel magnetic spokes are arranged at intervals around a center wheel hub. Each permanent magnet spoke is attached in sequence to the center hub. Each magnetic spoke is adhered to the center hub alternating the north and south pole orientation of each magnet. They are arranged in a pattern of four or more spokes and adhered to the wheel to form a tire. The spokes are designed such that in addition to being permanent magnets they transmit the power from the hub to the rubber tube of the wheel. It performs two functions. To hold the entire bicycle/vehicle—The whole weight of the bicycle/vehicle, is concentrated on the hub. The spokes hold this hub and transfer the weight to rim of the wheel. The entirety of the spokes are covered by permanent magnets. The magnetic field directions generated by the permanent steel magnets are consistent and all face the inner side or the outer side of the rotor.

In Device 2 the electrodes and the permanent magnets are fixed in the wheel cover/well. The wheel-based range extender charger Device 2 operates in much the same way as Device 1, however, in Device 2 the wheel spokes are wound with copper wire to create the armature winding and thereby making this the rotor assembly. While the permanent magnets are place in the wheel well or wheel cover. The wheel well permanent magnets are stationary in this device.

The Grayson Range Extender can be built into the wheel well of the electric vehicle, placed in a side car based system mounted alongside the vehicle or towed behind the vehicle in a portable charging system which is essentially a mobile commercial generator that uses the same principle of converting the mechanical energy of the tire into electricity. The system utilizes a trailer mounted GRE that resides in standby mode until a low charge signal is received from the vehicle. While the vehicle is being driven, the tethered trailer activates the generator, which in turn recharges the EV battery or powers the vehicle directly. The idea is that this charge on the go system will negate the need for lengthy charging stops. By the wheel cover type generator of the range extender for the electric vehicle, the overall vehicle range can be effectively increased to rival and exceed that of gasoline powered vehicles.

In order to gain exponential range extension, provide more power for greater horsepower, create a platform that will have immediate and long-term environmental benefits while simultaneously reducing charging times, improving EV overall efficiency, the present invention adopts following technical scheme:

A kind of electric vehicle recharging system that greatly extends the range of any vehicle, said tire-based range extender device, Grayson Range Extender (GRE), is characterized in that:

Comprise a wheel cover-based armature winding, wheel spoke based permanent magnets, tires, charge controller and battery bank, axle, magnetic conductive soft iron;

Magnetic conductive soft iron and permanent magnet are spaced and are bonded to the wheel spokes, a magnetic conductive soft iron and a set of permanent magnets pole in a pair;

Permanent magnet has multi-spoke and in circular arc, the magnetic direction that all permanent magnets produce is consistent; In Device 2 the Armature winding is in a circular arc.

Quantity, the shape and size of described magnetic conductive soft iron are consistent with permanent magnet and size of the wheel; or in Device 2 the size of the wheel well/cover;

Wheel cover casing is fixed on rear vehicle body panels, wheel cover casing is movable on front body panels and stator core is fixed on wheel well/cover, rotor is fixed on spokes of the rim, and as wheel rotates around the axle the rotor can rotate around stator core wheel cover casing thereby inducing electricity.

A kind of electric vehicle recharging system that greatly extends the range of any vehicle, said wheel-based range extender device, Grayson Range Extender (GRE), as above, is characterized in that:

The permanent magnet and magnetic conductive soft iron can be mounted on the wheel cover/well or the wheel spokes, this then becomes the stator assembly;

A rotor phase winding can be wrapped around the spokes of the wheel or wrapped around an armature and placed in the wheel cover;

Because this is a frictionless system the power produced is scalable to the desired recharge time and range;

### Beneficial Effect of the Present Invention is as Follows

(1), system increases the range of an electric vehicle up to 400%;

(2) compared with traditional range extenders this device requires no additional fuels;

(3), compared with traditional tire-based generators this device has much greater charging capacity and reliability;

(4), compared with other types of wheel based recharging systems like regenerative breaking and bike generators, this system has lower coefficient of friction, generates a negligible amount of heat and is infinitely more reliable;

(5) can be very applicable and installed on all existing Electric Vehicles;

(6) compared to other range extenders this device lowers the sprung weight of the vehicle;

(7) compared to other range extenders this device has zero emissions.

### Accompanying Drawing Explanation

### Embodiment

Below in conjunction with accompanying drawing, the invention is described in further details.

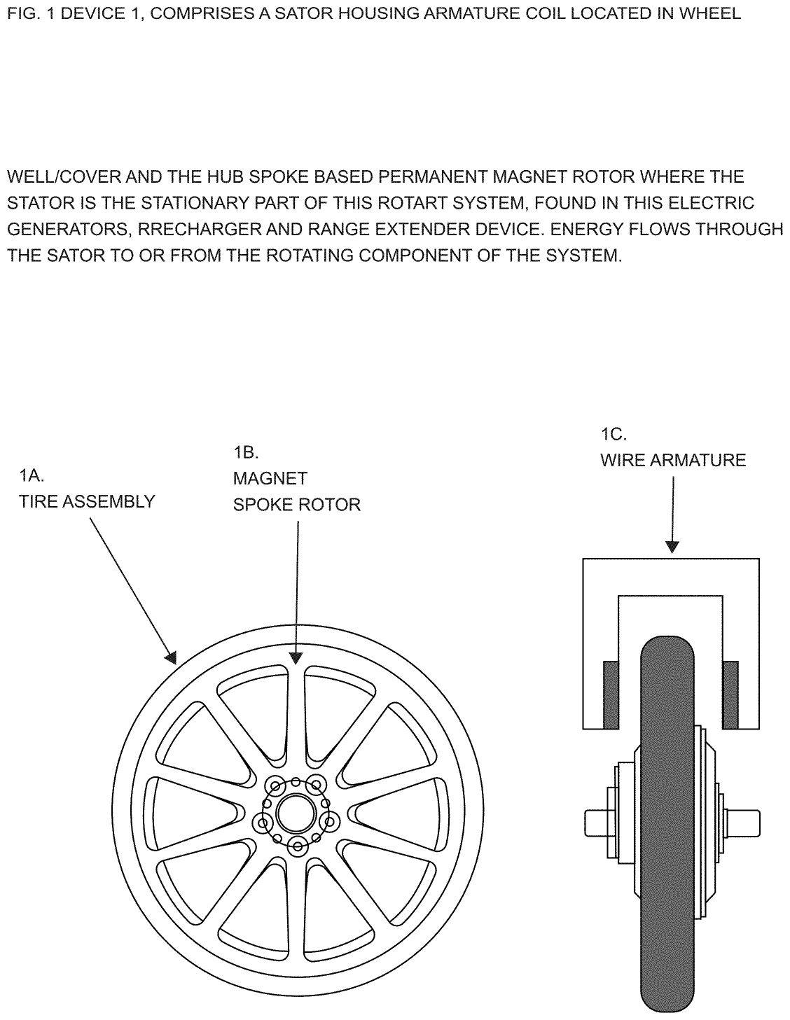

FIG. 1 is the sectional view of a kind of wheel-type electric vehicle generator range extender and recharger of the present invention, the Grayson Range Extender (GRE). Wherein: In this device, the rotor provides a rotating magnetic field that drives the rotating armature; the rotor is connect to the wheel and takes advantage of the rotational energy of the tire; in this generator range extender charger device, the stator coil, located in the wheel well/cover converts the rotating magnetic field of the rotor, located in the tire spokes, into an electric current which is used to recharge the battery bank or power the vehicle.

Depending on the configuration of a spinning electromotive device the stator may act as the field magnet(device A), interacting with the armature to create motion, or it may act as the armature, receiving its influence from moving field coils on the roto(Device 2)r. The first Device generator (known as device 1) puts the field coils on the stator, and the power generation or motive reaction permanent magnets on the rotor.

The stator of these devices may be either a permanent magnet or an electromagnet. Where the stator is an electromagnet, the coil which energizes it is known as the field coil or field winding. The coil can be either iron core or aluminum. To reduce loading losses in the device copper can be used as the conducting material in windings. Aluminum, because of its lower electrical conductivity, may be an alternate material. The device is able to produce power across multiple high-current power generation coils connected in parallel. Placing the field coils on the stator allows for an inexpensive mechanism to transfer high-voltage, low current power to the field coil.

In the case of Device 1 the magnet wire or enameled wire is wound tightly around an iron core and fashioned such that it is encompassed by the wheel cover. This armature takes up a large percentage of the wheel well or cover. This assembly constitutes the stator body housing. This armature winding is completely concealed by the wheel cover/well and is in the shape of the wheel cover. This dense magnet wiring cluster forms the first major segment of the Device 1 generator. There are several layers of wire in this cluster. The armature coil is stationary.

The rotor in comprised or permanent magnets which are incorporated in the wheel spokes. The armature coil assembly converts the mechanical energy of the rotating tire into electrical energy by passing the wheel through this armature winding. Said wheel, which houses the permanent magnets in the wheel spokes. The wheel thus becomes the rotor. The Rotor produces rotating magnetic flux or rotating magnetic field associated with the rotor inducing electricity in the armature coil attached to the wheel well or wheel cover.

Electrodes made of soft iron and permanent steel magnets spokes are arranged at intervals around a center wheel hub. Each permanent magnet spoke is attached in sequence to the center hub. Each magnetic spoke is placed on the center hub alternating the north and south pole of each magnet. They are arranged in a pattern of four or more spokes and adhered on the wheel to form a tire. The spokes are designed such that in addition to being permanent magnets they transmit the power from the hub to the rubber tube of the wheel.

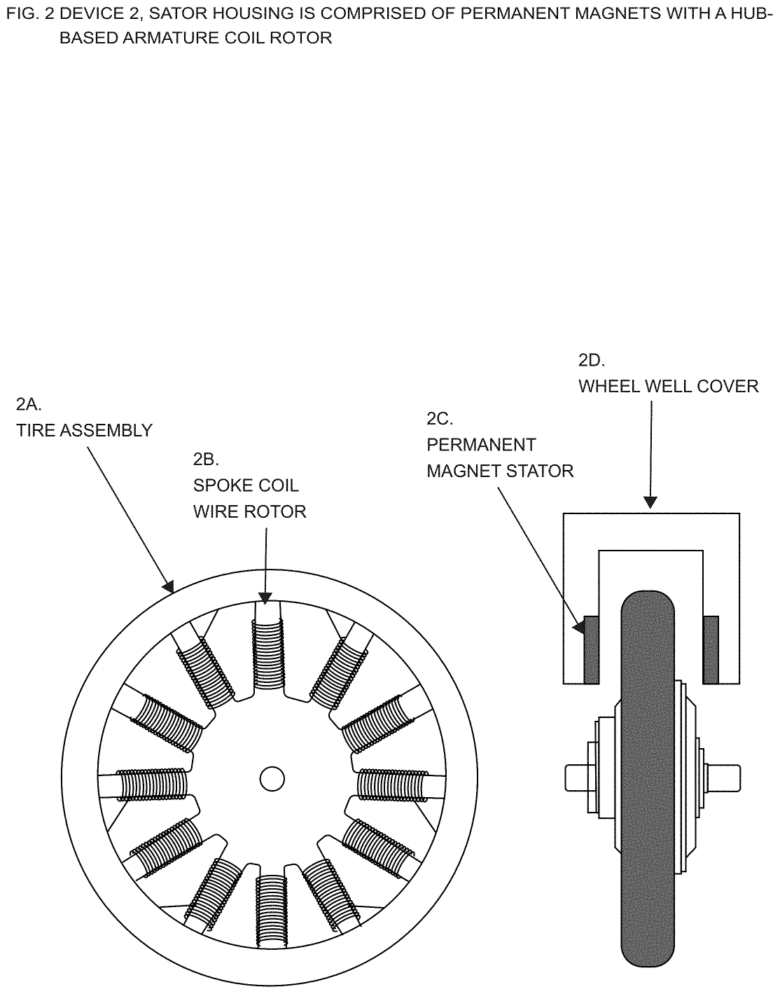

FIG. 2 is the sectional view of a kind of wheel-type electric vehicle generator range extender and recharger of the present invention, the Grayson Range Extender (GRE). Wherein:

The rotor is the moving component of this electromagnetic system in this electric generator recharger range extender. Its rotation is due to the interaction between the windings and magnetic fields which produces a torque around the rotor's axis. This device can be characterized as an induction (asynchronous) generators recharger range extender because it has an electromagnetic system consisting of a stator and rotor. There are two designs for the rotor in this induction motor: squirrel cage and wound. In this generator recharger range extender, the rotor designs are salient pole or cylindrical.

The Squirrel-cage rotor design consists of laminated steel in the core with evenly spaced bars of copper or aluminum placed axially around the periphery, permanently shorted at the ends by the end rings. Bearings at each end mount the rotor in its housing, with one end of the shaft protruding to allow the attachment of the load. The generated torque forces motion through the rotor to the load.

The Wound rotor design consist of a cylindrical core made of steel lamination with slots to hold the wires for its 3-phase windings. The rotor winding terminals are brought out and attached to the three slips rings with brushes, on the shaft of the rotor.

The Salient pole rotor is a large magnet with poles constructed of steel lamination projecting out of the rotor's core. The poles are supplied by direct current or magnetized by permanent magnets.

The armature with a three-phase winding is on the stator where voltage is induced. The rotor shaft produces a magnetic field and energizes the rotating field windings and alternating current energizes the armature windings simultaneously. Device 1)

Non-Salient rotor or the cylindrical shaped rotor is made of a solid steel shaft with slots running along the outside length of the cylinder for holding the field windings of the rotor which are laminated copper bars inserted into the slots and is secured by wedges. The slots are insulated from the windings and are held at the end of the rotor by slip rings. (Device 2)

In the case of Device 2 the magnet wire or enameled wire is wound tightly around an iron core and fashioned such that it encompasses the wheel spoke. This armature winding takes up a large percentage of the wheel spoke. This assembly constitutes the rotor. This dense magnet wiring cluster forms the first major segment of the Device 2 generator. There are several layers of wire in this cluster. The rotor in comprised of wiring clusters around each wheel spoke.

The armature coil assembly converts the mechanical energy of the rotating tire into electrical energy by passing the wheel through the permanent magnet cluster. Said wheel, which houses the armature coil on the wheel spokes. The wheel thus becomes the rotor. The Rotor produces rotating magnetic flux or rotating magnetic field associated with the rotor inducing electricity in the permanent magnet cluster attached to the wheel well or wheel cover.

Electrodes made of soft iron and tightly wired armature spokes are arranged at intervals around a center wheel hub. Each armature spoke is attached in sequence to the center hub They are arranged in a pattern of five or more spokes and adhered on the wheel to form a tire. The spokes are designed such that in addition to being wired armatures they transmit the power from the hub to the rubber tube of the wheel.

The stator is comprised of permanent magnets which are incorporated in the wheel well/cover The stator assembly converts the mechanical energy of the rotating tire into electrical energy by passing the armature coil spokes through the permanent magnet assembly. The magnetic wheel cover cluster is placed attached to the wheel well alternating the north and south pole of each magnet.

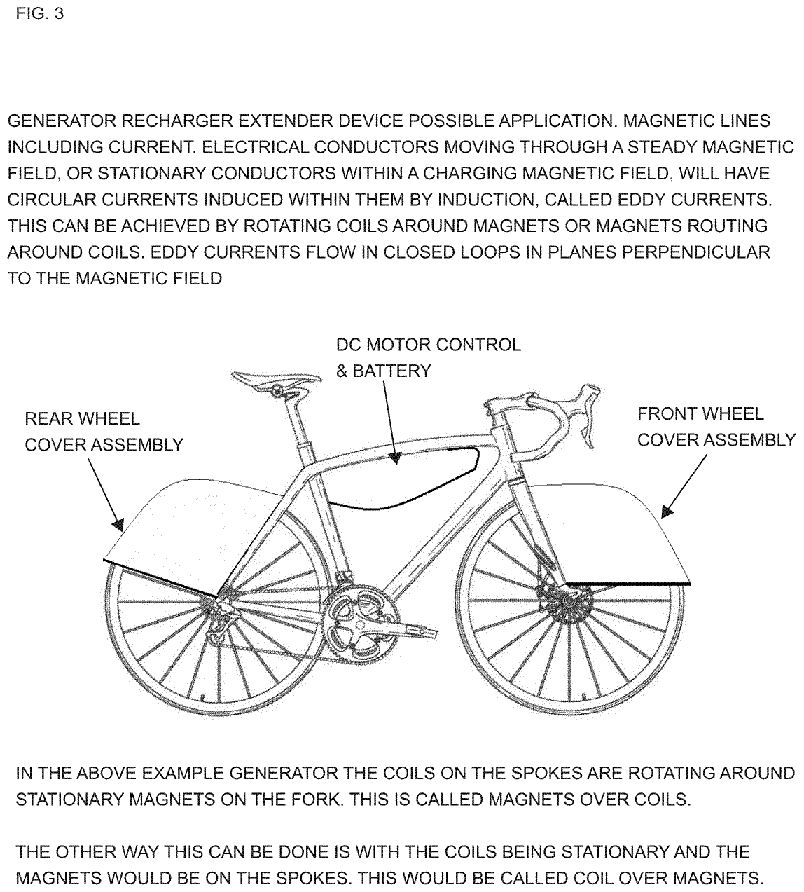

FIG. 3 is the sectional view of a kind of wheel-type electric vehicle generator range extender and recharger of the present invention, the Grayson Range Extender (GRE). Wherein:

A field coil is an electromagnet used to generate a magnetic field in an electro-magnetic machine, typically a rotating electrical machine such as this generator recharger range extender. It consists of a coil of wire through which a current flow.

In a rotating machine, the field coils are wound on an iron magnetic core which guides the magnetic field lines. The magnetic core is in two parts; a stator which is stationary, and a rotor, which rotates within it. The magnetic field lines pass in a continuous loop or magnetic circuit from the stator through the rotor and back through the stator again. The field coils may be on the stator or on the rotor.

The magnetic path is characterized by poles, locations at equal angles around the rotor at which the magnetic field lines pass from stator to rotor or vice versa. The stator (and rotor) are classified by the number of poles they have. Most arrangements use one field coil per pole. Some older or simpler arrangements use a single field coil with a pole at each end.

Stators and Rotors

Many rotary electrical machines require current to be conveyed to (or extracted from) a moving rotor, usually by means of sliding contacts: a commutator or slip rings. These contacts are often the most complex and least reliable part of such a machine and may also limit the maximum current the machine can handle. For this reason, when machines must use two sets of windings, the windings carrying the least current are usually placed on the rotor and those with the highest current on the stator.

The field coils can be mounted on either the rotor or the stator, depending on whichever method is the most cost-effective for the device design.

For generators, the field current is smaller than the output current. [note 2] Accordingly, the field is mounted on the rotor and supplied through slip rings. The output current is taken from the stator, avoiding the need for high-current sliprings. In DC generators, which are now generally obsolete in favor of AC generators with rectifiers, the need for commutation meant that brush gear and commutators could still be required. For the high-current, low-voltage generators used in electroplating, this could require particularly large and complex brush gear.

By increasing the number of pole faces surrounding the Gramm ring, the ring can be made to cut across more magnetic lines of force in one revolution than a basic two-pole generator. Consequently, a four-pole generator could output twice the voltage of a two-pole generator, a six-pole generator could output three times the voltage of a two-pole, and so forth. This allows output voltage to increase without also increasing the rotational rate.

In a multipolar generator, the armature and field magnets are surrounded by a circular frame or “ring yoke” to which the field magnets are attached. This has the advantages of strength, simplicity, symmetrical appearance, and minimum magnetic leakage, since the pole pieces have the least possible surface and the path of the magnetic flux is shorter than in a two-pole design.[1]

Winding Materials

Main Article: Windings

Coils are typically wound with enameled copper wire, sometimes termed magnet wire. The winding material must have a low resistance, to reduce the power consumed by the field coil, but more importantly to reduce the waste heat produced by ohmic heating. Excess heat in the windings is a common cause of failure. Owing to the increasing cost of copper, aluminum windings are increasingly used.

An even better material than copper, except for its high cost, would be silver as this has even lower resistivity. Silver has been used in rare cases. During World War Ili the Manhattan project to build the first atomic bomb used electromagnetic devices known as calutrons to enrich uranium. Thousands of tons of silver were borrowed from the U.S. Treasury reserves to build highly efficient low-resistance field coils for their magnets.[2][3] Showing the magnetic lines inducing current. Electrical conductors moving through a steady magnetic field, or stationary conductors within a changing magnetic field, will have circular currents induced within them by induction, called eddy currents. Eddy currents flow in closed loops in planes perpendicular to the magnetic field.

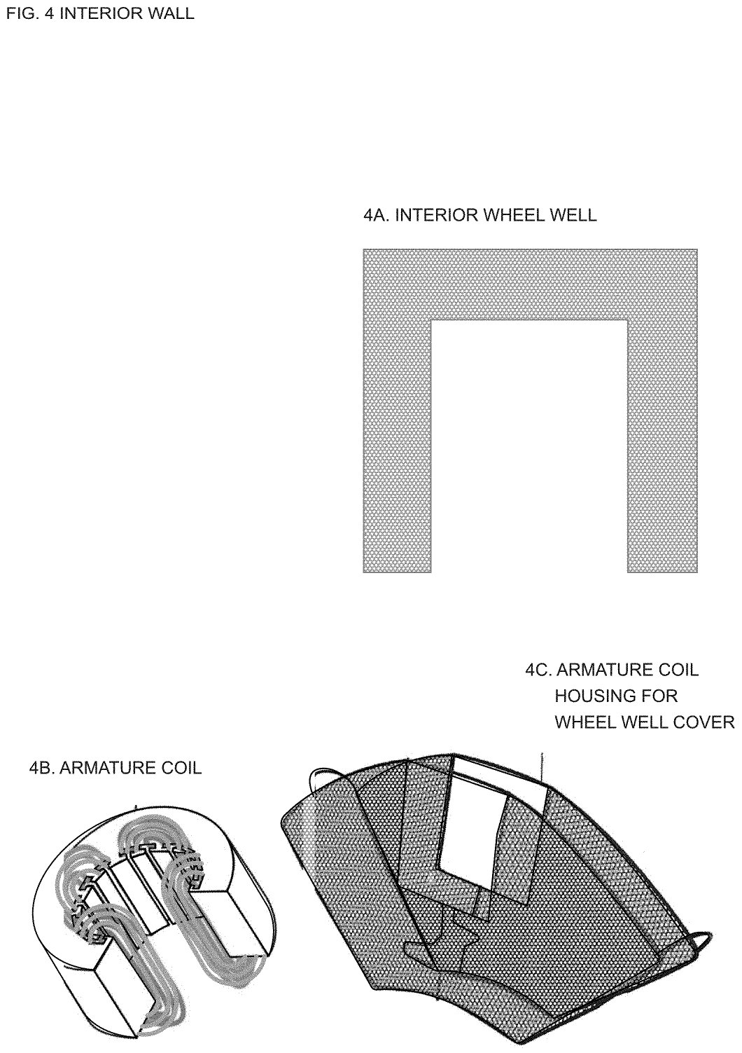

FIG. 4 is the sectional view of a kind of wheel-type electric vehicle generator range extender and recharger of the present invention, the Grayson Range Extender (GRE). Wherein:

Charge Controller The electricity produced is then diverted to the charge controller. The charge controller now powers the engine directly or recharges the battery based on the needs of the pre-programmed needs vehicle. A charge controller, charge regulator or battery regulator limits the rate at which electric current is added to or drawn from electric batteries. It prevents overcharging and may protect against overvoltage, which can reduce battery performance or lifespan and may pose a safety risk. It may also prevent completely draining (“deep discharging”) a battery, or perform controlled discharges, depending on the battery technology, to protect battery life. The terms “charge controller” or “charge regulator” may refer to either a stand-alone device, or to control circuitry integrated within a battery pack, battery-powered device, or battery charger. The charge controllers may also be called a power regulator. The charge controller has additional features, such as a low voltage disconnect (LVD), a separate circuit which powers down the load when the batteries become overly discharged (some battery chemistries are such that over-discharge can ruin the battery). A series charge controller or series regulator disables further current flow into batteries when they are full. A shunt charge controller or shunt regulator diverts excess electricity to an auxiliary or “shunt” load, such as an electric water heater, when batteries are full. Simple charge controllers stop charging a battery when they exceed a set high voltage level and re-enable charging when battery voltage drops back below that level. Pulse width modulation (PWM) and maximum power point tracker (MPPT) technologies are more electronically sophisticated, adjusting charging rates depending on the battery's level, to allow charging closer to its maximum capacity. A charge controller with MPPT capability frees the system designer from closely matching available PV voltage to battery voltage. Considerable efficiency gains can be achieved, particularly when the PV array is located at some distance from the battery. By way of example, a 150 volt PV array connected to an MPPT charge controller can be used to charge a 24 or 48 volt battery. Higher array voltage means lower array current, so the savings in wiring costs can more than pay for the controller. Charge controllers may also monitor battery temperature to prevent overheating. Some charge controller systems also display data, transmit data to remote displays, and data logging to track electric flow over time. Circuitry that functions as a charge regulator controller may consist of several electrical components, or may be encapsulated in a single microchip, an integrated circuit (IC) usually called a charge controller IC or charge control IC.

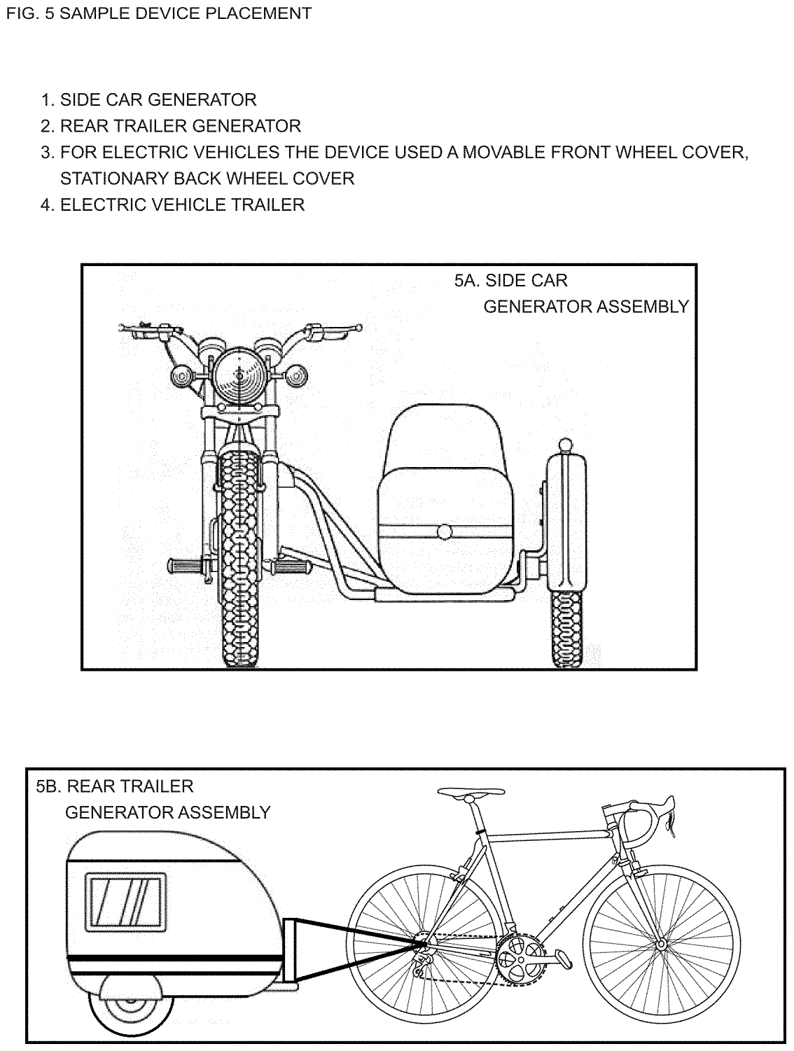

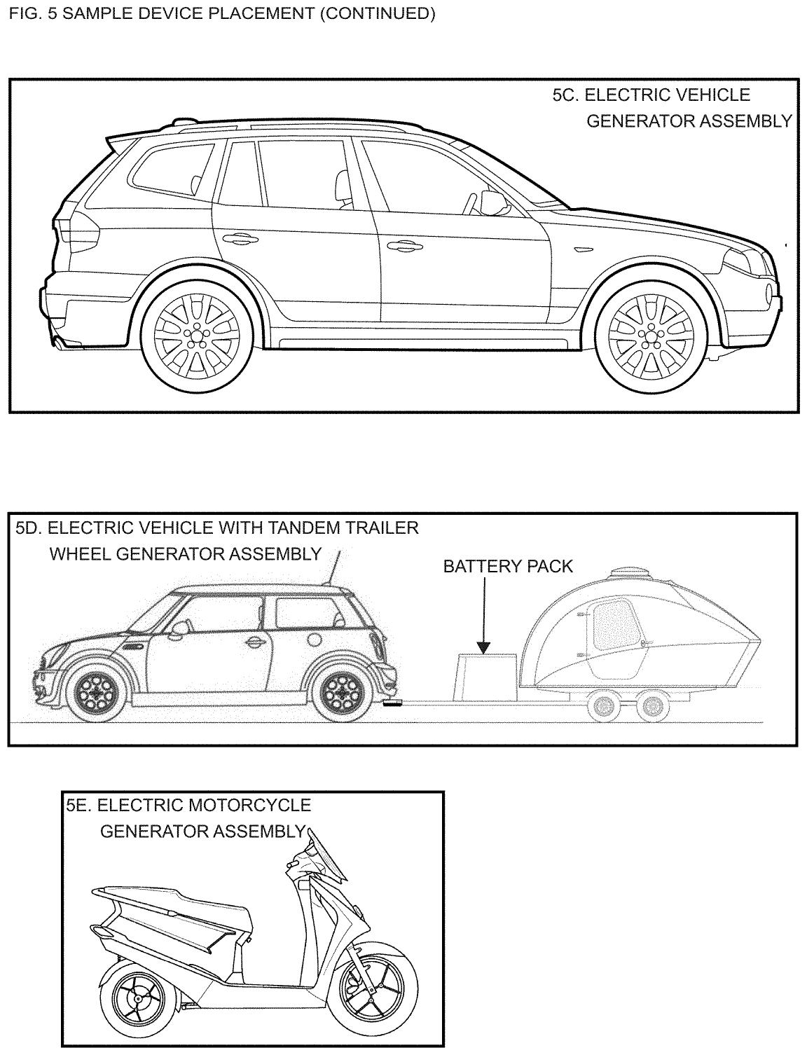

FIG. 5 is the sectional view of a kind of wheel-type electric vehicle generator range extender and recharger of the present invention, the Grayson Range Extender (GRE). Wherein:

### Sample Device Placement

1. Side car generator
2. Rear trailer generator
3. For electric vehicles the device uses a movable front wheel cover, stationary back wheel cover.
4. Electric vehicle trailer

1. An electric vehicle generator range extending charging system comprising;
a rotating wheel-based rotor comprising of permanent magnets which are affixed to the wheels, usually by adhering them to the spokes of the wheel;
a coiled copper, magnet or enameled wire tightly wound around a sufficiently large armature which is housed in the wheel well/cover, said wheel passes through the wheel well and thus passes through the armature;
a charge controller which directs the flow of electricity either to the vehicle or the battery bank.

2. The electric vehicle generator range extending charging system according to claim 1, wherein said device components of the present invention, as generally described could be arranged and designed in a wide variety of different configuration, the second primary design is such that an electric vehicle range extending charging system comprising;
a rotating wheel-based rotor comprising of tightly wound wire usually around each wheel spoke which are affixed to the wheels;
a permanent magnet armature which is housed in the wheel well/cover. The wheel passes through the wheel well and thus passes through the armature; and
a charge controller which directs the flow of electricity either to the vehicle or the battery bank.

3. The electric vehicle generator range extending charging system according to claim 1, wherein the rotational energy of the moving vehicle powers the generator such that as the permanent magnets pass through the coil field of the copper wire where electricity is produced said electricity is used to power the vehicle or recharge the battery bank.

4. The electric vehicle generator range extending charging system according to claim 2, wherein the rotational energy of the moving vehicle powers the generator such that as the permanent magnets pass through the coil field of the copper wire where electricity is produced, said electricity is used to power the vehicle or recharge the battery bank.
